(19) United States
(12) Patent Application Publication
(10) Pub. No.: US 2026/0105159 A1
(43) Pub. Date: Apr. 16, 2026

(54) ADAPTIVE MODEL INFORMATION FLOW ANALYSIS

(71) Applicant: Cycuity, Inc., San Jose, CA (US)

(72) Inventors: Jason K. Oberg, Redwood City, CA (US); Vijay Seshadri, San Jose, CA (US)

(21) Appl. No.: 19/251,314

(22) Filed: Jun. 26, 2025

Related U.S. Application Data
(60) Provisional application No. 63/665,973, filed on Jun. 28, 2024.

(51) Int. Cl. G06F 21/57

(52) U.S. Cl. CPC G06F 21/577; G06F 2221/034

(57) ABSTRACT

Methods, systems, and apparatus, including computer programs encoded on computer storage media for performing information flow analysis on hardware designs to identify vulnerabilities. One of the methods includes performing an information flow tracking process by feeding a different value through a duplicate input of a duplicate module in a modified hardware design whenever a value is provided to an original module in the modified hardware design having a particular security label. The outputs of the duplicate module and the original module are evaluated using combination logic to determine whether the value can flow through the module.

### CROSS-REFERENCE TO RELATED APPLICATIONS

This application claims priority to U.S. Provisional Application No. 63/665,973, filed on Jun. 28, 2024. The disclosure of this prior application is considered part of and is incorporated by reference in this disclosure of this application.

### BACKGROUND

This specification relates to analyzing the designs of electronic devices to identify and prevent vulnerabilities.

Vulnerabilities in the hardware designs of electronic devices can make such devices susceptible to leaking of sensitive information or susceptible to malicious attacks that can modify how the device works. It is particularly important to identify such vulnerabilities in the design phase because such vulnerabilities may not be fixable after fabrication, unlike a software vulnerability that can be fixed with a patch. However, identifying such vulnerabilities has typically relied on pre-fabrication manual inspection. Conventional approaches essentially require guessing the security weaknesses and then either building a mitigation or performing manual penetration testing to see if there is actually a problem.

One complication of assessing hardware designs for vulnerabilities is that many hardware design tools have entities that are not synthesizable. This means that for various reasons a full hardware design of the module is unavailable, and the functionality of the module is emulated or implemented by a behavioral model.

### SUMMARY

This specification describes how a hardware design can be automatically analyzed with information flow tracking techniques to identify or mitigate the likelihood of vulnerabilities, even when the design includes unsynthesizable elements. More specifically, a hardware design system can use dual-model techniques that use duplicate modules in order to identify modules through which vulnerable information can inadvertently flow.

In this specification, a duplicate module is a functional copy of an original module, e.g., a duplicate in behavior. That is, the duplicate module of an original module can include one or more inputs that correspond respectively to one or more inputs of the original module, one or more outputs that correspond respectively to one or more outputs of the original module and can be configured to perform the same internal function as the original module.

Particular embodiments of the subject matter described in this specification can be implemented so as to realize one or more of the following advantages.

The techniques described in this specification provide a foundation for unique insights into difficult-to-detect vulnerabilities in hardware designs and automatically guide physical implementation decisions throughout the semiconductor design process. By leveraging information representing where information flows in a design, a system can automatically identify security critical aspects of a hardware design to detect vulnerabilities and/or change the structure of the chip to mitigate them after manufacturing. In many cases this will make it possible to identify and mitigate issues that would be impossible to fix post-silicon, and which may lead to product recalls or a weakening of the security posture of microelectronics that are critical to modern systems.

Furthermore, the techniques described in this specification provide a manner to detect vulnerabilities in unsynthesizable modules, e.g., modules that cannot be synthesized to a hardware gate level representation. By introducing a duplicate module, or a “copy” of the original module, the system can identify security critical aspects of a hardware design to detect vulnerabilities without knowing and/or altering the internal design and/or internal function of the module.

The details of one or more embodiments of the subject matter will become apparent from the description, drawings, and the claims. Other features, aspects, and advantages of the subject matter will become apparent from the description, drawings, and the claims.

### BRIEF DESCRIPTION OF THE DRAWINGS

FIGS. 1A and 1B are visualizations of using information flow tracking to perform confidentiality and integrity analyses.

FIG. 2 illustrates an example modified hardware design including a duplicate module.

FIGS. 3A and 3B illustrate example information flow tracking processes using the modified hardware design.

FIG. 4 is a flow chart of an example process for generating and utilizing the hardware design to determine whether vulnerable information can flow through a module.

Like reference numbers and designation in the various drawings indicate like elements.

### DETAILED DESCRIPTION

This specification generally describes a computer-implemented hardware design system that utilizes information flow tracking through a module to identify security vulnerabilities. In particular, the hardware design system can automatically modify an original hardware design having a module to include a duplicate module with the same or similar port signature. For an input that carries with it a particular label, e.g., a security label indicating that the input is tainted or secret, the input to the duplicate module can be different, while otherwise, the inputs to the duplicate module are the same as those fed to the original module. By comparing the output of the original module with that of the duplicate module, the system can determine whether the tainted or secret input was able to flow through the duplicate module, and thus, can flow through the original module in the original hardware design.

A duplicate module whose functionality is identical to the original module may in some instances also be referred to as a shadow module.

In this specification, a port signature describes the interface of the module in terms of its input and output ports. In other words, the duplicate module can have the same or similar inputs and outputs as the original module to help the system perform a direct comparison on how vulnerable information may flow through the hardware design.

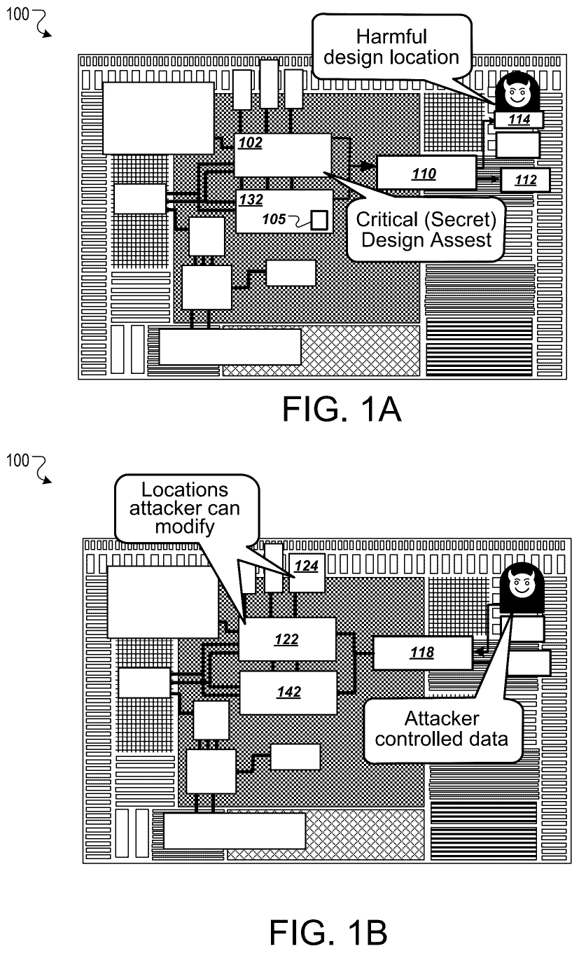

FIGS. 1A and 1B are visualizations of using information flow tracking to perform confidentiality and integrity analyses.

As shown in FIG. 1A, information flow tracking can be used to determine where in a hardware design a critical design asset 105 can flow. Information flow tracking can be used to determine whether the critical design asset 105 can flow to a potentially harmful design location, e.g., the component 114, which might be a location where it can be accessed by an attacker. The techniques described in this specification can be used to determine that the critical design asset 105 can flow from an initial component 102, also referred to as a module 102, to other components 110, 112, and 114 by introducing an additional duplicate module 132 through which the critical design asset 105 flows. More specifically, the duplicate module 132 can be used to compare the output of the (original) module 102 to the output of the duplicate module 132 to determine whether the critical design asset 105 can flow through the module 102. If the two outputs differ, the system 100 can determine that the critical design asset 105 did flow through the duplicate module 132 and therefore, can flow through the module 102. The last component 114 is a potential harmful design location because it is a portion of the device that is potentially accessible by an attacker. Thus, through information flow tracking techniques, the system 100 can determine whether vulnerabilities can flow through the module 102 (and through one or more other components/modules) to a potential harmful design location to be accessed by an attacker.

As shown in FIG. 1B, information flow tracking can also be used to determine what items can be modified due to the introduction of attacker-controlled data at a particular point in the design. That is, information flow tracking can be used to determine how attacker-specified data might flow through components 118, 122 and 124, which can be a location that stores settings or configurations. Similarly to the above example shown in FIG. 1A, to do so, the system 100 can generate a duplicate module 142 for (original) module 122 to determine how data might flow through (original) module 122. The system 100 can determine whether the data might flow through the module 122 by sending attacker specific data through the duplicate module 142 and comparing the output of the duplicate module 142 to the module 122. If the two outputs differ, the system 100 can determine that the attacker specified data did flow through the duplicate module 142 and therefore, can flow through the module 122. Thus, the information flow tracking techniques described in this specification can identify how such an information flow can cause the device to be modified in unexpected ways.

In other words, the techniques described in this specification can be used to determine whether vulnerable information can flow to a potentially harmful design location and/or whether harmful attacker controlled data can flow through and potentially modify a hardware design. That is, the techniques described in this specification can be used to determine whether vulnerable information can flow to bad locations (e.g., hacker accessed locations) or bad information (e.g., attacker controlled information) can flow through vulnerable locations (e.g., locations that can be altered and/or store information that can be altered by the bad information).

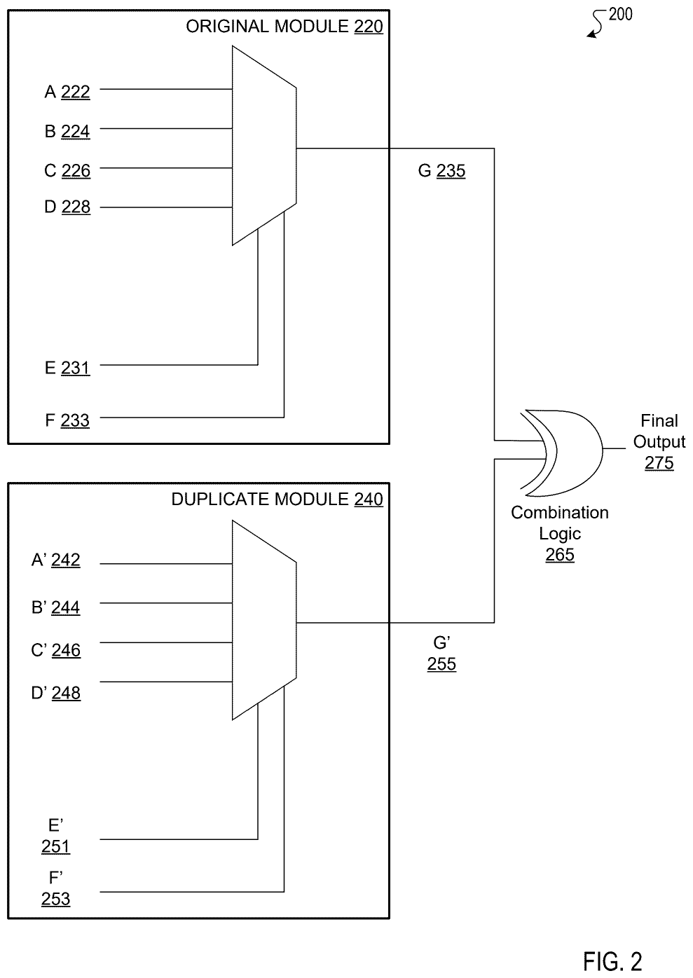

FIG. 2 illustrates an example modified hardware design used to identify whether vulnerable information flows through an original module 220.

The modified hardware design can include the addition of a duplicate module 240 and combination logic 265 to the original hardware design.

The system 200 can generate a modified hardware design that includes a duplicate module 240 that is identical to the original module 220 to track vulnerable information through the original hardware design. That is, to determine whether vulnerable information can flow through the original module 220, the system 200 can generate a duplicate module 240 that includes duplicate inputs that correspond to the inputs of the original module. The system 100 can compare the flow of information through the original module 220 with the flow of the vulnerable information through the duplicate module 240 using combinational logic 265 to determine whether the vulnerable information flows through the duplicate module 240 and thus, can flow through the original module 220.

To do so, the system 200 can receive an initial hardware design having an original module 220 with one or more original inputs for tracking a value through the initial hardware design.

The original module 220 can be any hardware module that performs a specific function or set of functions with any port signature, e.g., any number and/or type of input and output ports.

For example, the original module 220 can have input port A 222, input port B 224, input port C 226, input port D 228, input port E 231, input port F 233, and output port G 235.

The system 200 can generate a modified hardware design that includes (i) adding a duplicate module 240 for the original module 220 and (ii) adding combination logic 265 that combines one or more outputs of the original module 220 with one or more outputs of the duplicate module 240 to generate a final output 275.

At a high level, the duplicate module 240 can be “copy” of the original module 220 with the same or similar port signature. That is, the duplicate module 240 can be an exact copy of the original module 220 that imitates the inputs, outputs, and internal function of the original module 220.

The duplicate module 240 can be added to the modified hardware design using any appropriate method. For example, the duplicate module 240 can be another instance of the original module in the hardware design (e.g., a duplicate of the hardware block). In this manner, the system 200 can add the duplicate module 240 to the modified hardware design without knowing and/or altering the internal function of the original module 220.

The system 200 can add a duplicate module 240 that includes one or more duplicate inputs that correspond respectively to the one or more inputs of the original module 220 and one or more duplicate outputs that correspond respectively to the one or more outputs of the original module 220.

For example, the duplicate module 240 can have duplicate input port A′ 242, duplicate input port B′ 244, duplicate input port C′ 246, duplicate input port D′ 248, duplicate input port E′ 25, duplicate input port F′ 253 and duplicate output port G′ 255. Each duplicate port, e.g., input and output port, can correspond to a respective input or output port of the original module 220. For example, input port A 222 corresponds to duplicate input port A′ 242, input port B 224 corresponds to duplicate input port B′ 244, output port G 235 corresponds to duplicate output port G′ 255, and so on for each of the duplicate inputs and outputs of the duplicate module 240.

While the duplicate module 240 can have the same or similar input ports, the values of the inputs to the duplicate module 240 can differ, in some instances, to the original module 220. The values of the inputs to the duplicate module 240 can be the same value as the original module 220, except when an input to the original module 220 carries with it a particular label, e.g., a security label indicating that the input is secret or “tainted”. For example, vulnerable information can carry with a security label of secret while attacker-controlled data can carry with a security label of “tainted.”

In the case of a security label, the input to the duplicate module 240 can differ from the corresponding input to the original module 220. By feeding a different value as input to the duplicate module 240 for an input that carries a security label, the system 200 can determine whether the information flows through the duplicate module 240 and thus, the original module 220 by determining if the different value modifies the output of the duplicate module 240 as compared to the original module 220.

As an example, the input port C 226 can carry a security label indicating that the input is secret or tainted and thus, the corresponding duplicate input port C′ 246 can receive a value that differs from the value fed through the input port C 226.

The different input fed through the duplicate input port can be any appropriate input that differs from the input fed through the corresponding original input port. As one example, the different inputs provided to the duplicate module 240 can be randomly generated predetermined values, or based on another type of function, e.g., an inversion function. For example, the value fed through the duplicate input port C′ 246 can be an inverse of the value fed through the input port C 226.

The original module 220 and the duplicate module 240 can perform the same internal function to generate respective outputs, e.g., original module output G 235 and duplicate module output G′ 255.

As described above, the duplicate module 240 can have the same number and type of outputs as the original module 220.

In some implementations, the original module 220 can have two or more outputs and thus, the duplicate module 240 can have two or more corresponding outputs to the outputs of the original module 220.

Along with the above described duplicate module 250, the system 200 can add combination logic 265 to the modified hardware design to determine whether the vulnerable information was able to flow through the module by comparing the outputs of the original module 220 with the duplicate module 240. The combination logic 265 can combine one or more outputs of the original module 220 with one or more outputs of the duplicate model 240 to generate a final output 275. For example, the combination logic 265 can combine the output G 235 from the original module 220 with the output G′ 255 from the duplicate module 240 to generate the final output 275.

The system 200 can perform the combination logic 265 on the respective output(s) of the original module 220 and the respective output(s) of the duplicate module 240 to determine whether the labeled value, e.g., a value with a security label of secret or tainted, was able to flow through the module.

The combination logic 265 can be any appropriate combination logic.

As a specific example, the combination logic 265 can include logic that performs an exclusive OR operation on a first output, e.g., G 235, of the original module 320 and a second output, e.g., G′ 255, of the duplicate module 240. In this example, the final output 275 of the combination logic 265 can be a binary value indicating whether the first output of the original module, e.g., G 255, is the same as the second output of the duplicate module 240, e.g., G′ 255. More specifically, the final output 275 can be a 1 if the respective output of the original module 220 and the duplicate module 240 differ, or a 0 if the respective output of the original module 220 and the duplicate module 240 are the same.

In other words, if the exclusive OR operation was not 0, this means that the labeled value can flow to the output of the original module 220.

In some implementations, the combination logic 265 can perform a pairwise comparison between outputs of the original module 220 and outputs of the duplicate module 240. That is, in some implementations, the original module 220 can generate one or more outputs, e.g., output G 235 and an output H, while the duplicate module 240 can generate one or more corresponding outputs, e.g., output G′ 255 and an output H′. As a specific example, the system 100 can perform an exclusive OR operation on each pair of outputs (e.g., a first output from the original module 220 and a corresponding first output from the duplicate module 240, a second output from the original module 220 and a corresponding second output from the duplicate model 240) and add the output of the pair-wise operations, e.g., either a 0 or a 1, together to generate a final output 275. That is, the output of the combination logic operation, e.g., the XOR logic 365, on a pair of outputs can be a 1 if the respective output of the original module 220 and the duplicate module 240 differ, or a 0 if the respective output of the original module 220 and the duplicate module 240 are the same. Each of the respective operation outputs can be added to determine the final output 275.

If the final output 275 is not 0, e.g., the operation output is not 0 for each pair of outputs, this means that the labeled value, e.g., the value that carries a security label of secret or tainted, was able to flow to the output of the duplicate module 240, and thus, can flow through the original module 220.

The system 200 can perform one or more actions in response to determining that the labeled value can flow through the original module 220.

In some implementations, the system 200 can reject the hardware design, indicating that the design needs to be revised, reworked, or abandoned to fix the vulnerabilities before the system 200 will accept the design.

In some implementations, the system 200 can generate a notification that the labeled information (e.g., secret, or tainted information) can flow through the original module 220 and therefore, is a security vulnerability.

In some implementations, the system 200 can display a warning that the labeled information (e.g., secret, or tainted information) can flow through the original module 220 and therefore, is a security vulnerability.

In some implementations, the modified hardware design can add two or more duplicate modules 240 to perform the information flow tracking process.

For example, a second duplicate module can be added to the modified hardware design to perform information flow tracking for a second different value to the second duplicate module.

In some implementations, the second different value of the second duplicate module can be for a different input of the original module 220 as the first different value of the first duplicate module. That is, the second different value of the second duplicate module can be a different value fed into duplicate input port C′ 246, while the first different value of the first duplicate module can be a different value fed into the duplicate input port A′ 242.

In some implementations, the second different value of the second duplicate module can be for the same input of the original module as the first different value of the first duplicate module. That is, the second different value of the second duplicate module can be a different value fed into duplicate input port A′ 242 than the first different value of the first duplicate module that is also fed into the duplicate input port A′ 242. The (first) duplicate module, e.g., duplicate module 240, and the second duplicate module can have different respective functions for generating the different values fed into the modules based on the value provided to the original module. That is, the (first) duplicate module can feed an inverse value into an input port and the second duplicate module can feed a predetermined value into a corresponding input port.

The combination logic 265 for the modified hardware system with two or more duplicate modules can be configured to combine the one or more outputs from the duplicate module and the second duplicate module.

The combination logic 265 can combine outputs from the one or more duplicate modules and the original modules and perform logic to generate the final output 275.

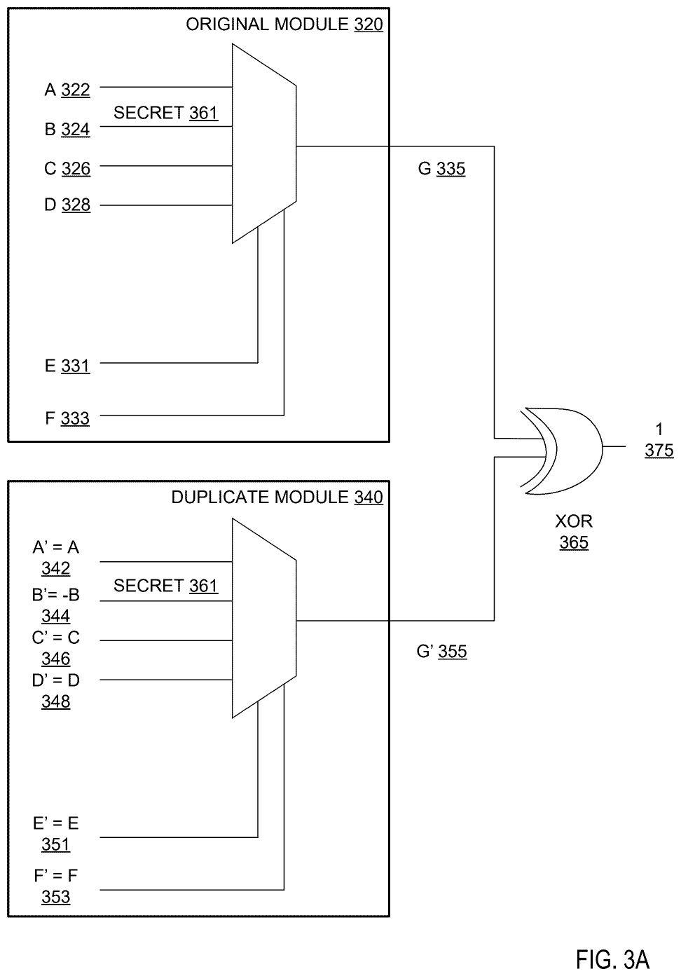

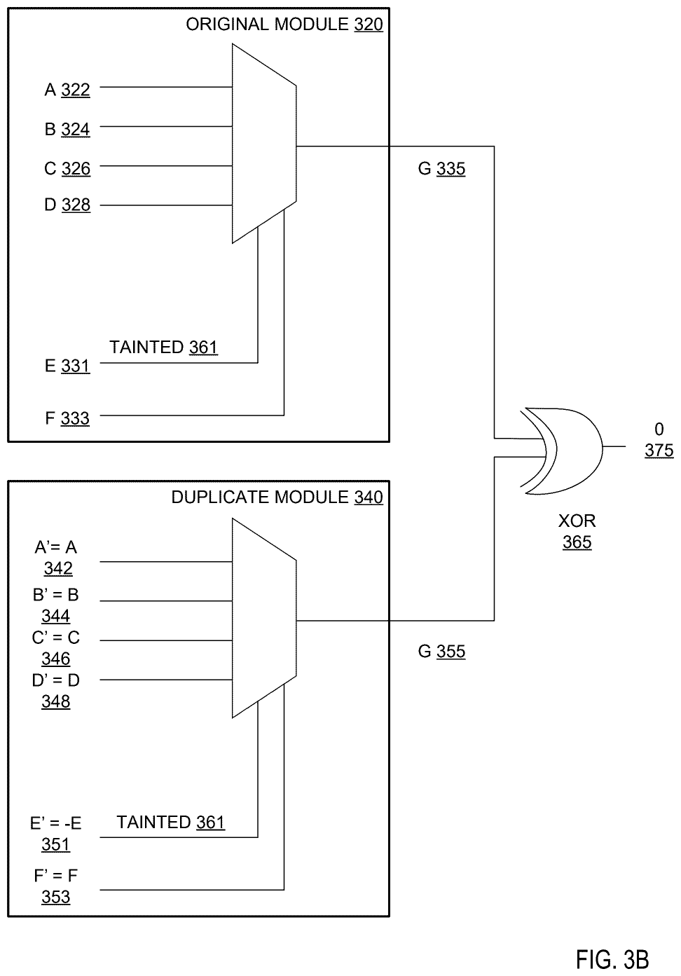

FIGS. 3A and 3B illustrate example information flow tracking processes for vulnerable information through an original module 320.

After generating the modified hardware design (as described above with reference to FIG. 2), the system 300 can perform an information flow tracking process including feeding a value through the modified hardware design by providing a different value to a duplicate input port whenever the value is provided to the original module 320 having a particular security label.

The system 300 can determine whether the value can flow through the original module 320 based on the final output of the combination logic.

In other words, the system 300 can track vulnerable information through the original module 320 by feeding the duplicate module 340 a different value for a value of the original module 320 that has a security label (e.g., secret or tainted), and comparing the outputs of the original module 320 and the duplicate module 340 using the combination logic.

For both examples illustrated in FIGS. 3A and 3B, the combination logic can be exclusive OR (XOR) logic 365.

FIG. 3A illustrates an example information flow tracking process for secret or tainted information that is able to flow through the original module 320.

As described above, the modified hardware design includes an original module 320, an additional duplicate module 340, and combination logic, e.g., XOR logic 365.

The original module 320 can receive inputs into input port A 322, input port B 324, input port C 326, input port D 328, input port E 331, and input port F 333 and generate an output value G 335.

In similar fashion, the duplicate module 340 can receive inputs into input port A′ 342, input port B′ 344, input port C′ 346, input port D′ 348, input port E′ 351, and input port F′ 353.

The duplicate module 340 can receive the same inputs as the corresponding inputs to the original module 320 for each input except for inputs that carry with it a particular label, e.g., a security label.

As seen in FIG. 3A, the input value that is fed into input port B 324 has a security label 361 attached to it that labels the input as secret. Thus, while input port A′ 342 of the duplicate module 340 receives the same input as input port A 322 of the original module, input port B′ 344 receives a different input than the input to input port B 324 of the original module 320 because of the security label 361. As a particular example, input port B′ 344 of the duplicate module 340 receives the inverse of the value that is fed into the input port B 324 of the original module 320.

The rest of the input ports of the duplicate module, e.g., input port C′ 346, input port D′ 348, input port E′ 351, and input port F′ 353 all receive the same values as their corresponding input ports of the original module 320.

The duplicate module 340 can process the inputs, including the inverse value fed into input port B′ 344, and generate an output G′ 355 that differs from output G 335.

The system 300 can combine the output G 335 from the original module 320 and the different output G′ 355 from the duplicate module 340. The system 300 can perform XOR logic 365 on the combined outputs of the original module 320 and the duplicate module 340 to generate a final output 375.

As mentioned above G 335 and G′ 355 are different and thus, the exclusive OR operation generates a value of 1 as the final output 375. From the final output 375 of 1, the system 300 can determine that the secret information did flow through the duplicate module 340 as it resulted in a different output. Thus, the vulnerable information fed into input port B 224 is able to flow through the original module 320 in the initial hardware design.

FIG. 3B illustrates an example information flow tracking process for secret information that is not able to flow through the original module 320.

As described above, the modified hardware design includes an original module 320, an additional duplicate module 340, and combination logic, e.g., XOR logic 365.

The original module 320 can receive inputs through input port A 322, input port B 324, input port C 326, input port D 328, input port E 331, and input port F 333 and generate an output value G 335.

In similar fashion, the duplicate module 340 can receive inputs through input port A′ 342, input port B′ 344, input port C′ 346, input port D′ 348, input port E′ 351, and input port F′ 353.

The duplicate module 340 can receive the same inputs as the corresponding inputs to the original module for each input except for inputs that carry with it a particular label, e.g., a security label.

As seen in FIG. 3B, the input value that is fed into input port E 331 has a security label 361 attached to it that labels the input as “tainted”. Thus, while input port A′ 342 of the duplicate module 340 receives the same input as input port A 324 of the original module, input port E′ 351 receives a different input than the input to input port E 331 of the original module 320. As a particular example, input port E′ 351 of the duplicate module can receive the inverse of the value that is fed into the input port E 331 of the original module 320.

The rest of the input ports, e.g., input port B′ 344, input port C′ 346, input port D′ 348, and input port F′ 353 all receive the same values as their corresponding ports of the original module 320.

The duplicate module 340 can process the inputs, including the inverse value fed into input port B′ 344, and generate an output G 355 that is the same as the output G 335 from the original module 320.

The system 300 can combine the output G 335 from the original module 320 and the different output G 355 from the duplicate module. The system 300 can then perform XOR logic 365 on the combined outputs of the original module 320 and the duplicate module 340 to generate a final output 375.

As G 335 and G 355 are the same, the exclusive OR operation can generate a value of 0 as the final output 375. From the final output of 0 375, the system 300 can determine that the secret information did not flow through the duplicate module 340 and further testing may need to be done to investigate and/or determine whether the secret information can flow through the duplicate module 340 or not.

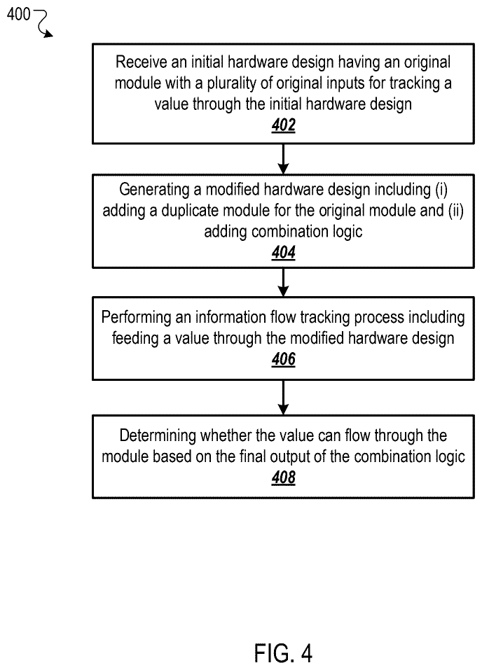

FIG. 4 is a flow chart of an example process for generating and utilizing the hardware design to determine whether vulnerable information can flow through a module.

For convenience, the process 400 will be described as being performed by a system of one or more computers located in one or more locations. For example, a system, e.g., the system 100 depicted in FIG. 1, appropriately programmed in accordance with this specification, can perform the process 400.

The system can perform the following steps of an information flow tracking process during any appropriate hardware design process. For example, the information flow tracking process described in this specification can be performed during a simulation process, a formal verification process, and/or a hardware emulation process.

The system can receive an initial hardware design having an original module with one or more original inputs for tracking a value through the initial hardware design (step 502).

The original module can be any hardware module configured to perform any function or set of functions with any port signature, e.g., any number and/or type of inputs and outputs.

The functionality of the original module can be implemented in any appropriate manner. In some implementations, the functionality of the original module is implemented by a software program. That is, a software program can be used to mimic the functionality of the hardware (e.g., how the hardware would behave) without need for the physical hardware itself. More specifically, the software program can simulate the original module by including code that replicates the behavior of the original module. For example, an adder can be represented by one or more lines of code that adds one or more inputs together and returns the sum.

In some implementations, the original module is a hardware module that is synthesizable in the hardware design. In this specification the term synthesizable refers to whether a piece of code in a hardware description language or the constructs and/or behaviors of the hardware module can be translated into actual hardware. In other words, a synthesizable module can be implemented directly in physical hardware.

In some implementations, the original module is a module that is not synthesizable in the hardware design. In this specification, the term unsynthesizable refers to a hardware module that cannot be translated into actual hardware. In other words, a synthesizable module cannot be implemented directly in physical hardware.

An original module can be unsynthesizable for a variety of reasons. Examples of reasons an original module is unsynthesizable include one or more components of the original module cannot be translated into hardware components (e.g., logic gates), the design of the original module can include a large memory, and the design including the original module is used for only for simulation. For example, a subcomponent of the original module can be “modeled” as hardware but written in a higher level language, e.g., SystemC, from which digital logic gates cannot be directly created. As another example, the design can include analog components that do not create any digital logic gates. In particular, analog components can be replaced by their analog equivalent, e.g., radio/antenna. As another example, the design can include large memories that map to special circuit structures. During the logic synthesis process, a memory will be mapped to these libraries prior to fabrication and there is not currently a scalable solution for modeling these memories in digital logic. As another example, the original module can be a simulation only module. More specifically, for example, the hardware design may include manual insert delays for the purpose of simulation. The delays are purely for modeling and do not result in any change to the logical structure and modules that use these cannot be translated into digital components.

The initial hardware design can specify at least hardware components, e.g., hardware modules, and which hardware components can communicate data to other hardware components. The initial hardware design may, but need not, have fully specified routing information about the exact routing assets that will connect the hardware components in the design. The initial hardware design can be in any appropriate format, e.g. hardware design language files, a netlist representation, or an application-specific format, to name just a few examples.

The system can generate a modified hardware design including (i) adding a duplicate module for the original module and (ii) adding combination logic that combines one or more outputs of the original module with one or more outputs of the duplicate module to generate a final output (step 504).

The duplicate module can be “copy” of the original module with the same or similar port signature. That is, the duplicate module can imitate the inputs, outputs, and internal function of the original module. Thus, as a copy of the original module, the duplicate module can be a hardware module configured to perform the function or the set of functions that the original module performs.

The combination logic can be any appropriate combination logic that is configured to combine and compare the output(s) of the original module with the output(s) of the duplicate module.

In some implementations, the modified hardware design can be generated by a software tool that parses a high-level security language. Such techniques for using high-level security languages are described in more detail in commonly-owned U.S. Pat. No. 10,289,873, which is incorporated herein by reference. Other techniques are described in more detail in commonly-owned U.S. Pat. No. 10,588,771, which is also incorporated herein by reference.

The system can perform an information flow tracking process including feeding a value through the modified hardware design, including providing a different value to a duplicate input whenever the value is provided to the module having a particular security label (step 506).

The system can perform an information flow tracking process through the modified hardware design by feeding a value through an input of the original module and feeding a different value to a corresponding duplicate input whenever the value is provided to the module having a particular security label.

The different value fed through the duplicate input port can be any appropriate input that differs from the input fed through the corresponding original input port. As one example, the different inputs provided to the duplicate module can be randomly generated predetermined values, or based on another type of function, e.g., an inversion function.

The security label can be a security label indicating that the input is secret or “tainted”. For example, vulnerable information can carry with a security label of secret while attacker-controlled data can carry with a security label of “tainted.”

The system can determine whether the value can flow through the module based on the final output of the combination logic (step 508).

In some implementations, the final output of the combination logic can be a binary value generated by performing an exclusive OR operation on the outputs of the original module and the duplicate module. The system can determine from the binary output whether the value can flow through the module. For example, if the final output is 1, then the value can flow through the module and if the final output is 0, then the value did not flow through the module.

In some implementations, the system can determine that the value can flow through the module based on the final output of the combination logic and in response, generate a notification that the value can flow through the module.

In some implementations, the notification can include automatically reporting a security violation in the initial hardware design.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are corresponded to in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes corresponded to in the accompanying figures do not necessarily require the particular order shown, or sequential order, to achieve desirable results. In some cases, multitasking and parallel processing may be advantageous.

What is claimed is:

1. A computer-implemented method comprising:
receiving an initial hardware design having an original module with a plurality of original inputs for tracking a value through the initial hardware design;
generating a modified hardware design including:
adding a duplicate module for the original module, the duplicate module having a plurality of duplicate inputs corresponding respectively to the plurality of inputs of the original module, and
adding combination logic that combines one or more outputs of the original module with one or more outputs of the duplicate module to generate a final output;
performing an information flow tracking process including feeding a value through the modified hardware design, including providing a different value to a duplicate input whenever the value is provided to the module having a particular security label; and
determining whether the value can flow through the module based on the final output of the combination logic.

2. The method of claim 1, wherein the duplicate module performs the same internal function as the original module.

3. The method of claim 1, wherein the original module is a module that is not synthesizable in the hardware design.

4. The method of claim 3, wherein functionality of the original module in the hardware design is implemented by a software program.

5. The method of claim 1, wherein the combination logic comprises logic that performs an exclusive OR between a first output of the original module and a second output of the duplicate module.

6. The method of claim 1, wherein the combination logic performs a pairwise comparison between a outputs of the original module and outputs of the duplicate module.

7. The method of claim 1, wherein providing different values to the duplicate module when the duplicate inputs have a particular security label.

8. The method of claim 1, further comprising providing the original value to the duplicate input whenever the value does not have the particular security label.

9. The method of claim 1, further comprising:
determining that the value can flow through the module based on the final output of the combination logic; and
in response, generating a notification that the value can flow through the module.

10. The method of claim 1, further comprising automatically reporting a security violation in the initial hardware design.

11. The method of claim 1, wherein the security label is an information flow tracking label.

12. The method of claim 1, further comprising:
adding a second duplicate module for the original module, wherein performing the information flow tracking process includes providing a second different value to the second duplicate module.

13. The method of claim 12, wherein the duplicate module and the second duplicate module have different respective functions for generating the different values based on the value provided to the original module, and wherein the combination logic is configured to combine one or more outputs from the duplicate module and the second duplicate module.

14. The method of claim 13, wherein the combination logic is configured to combine outputs from one or more duplicate modules and the original module.

15. The method of claim 1, wherein providing the different value comprises providing an inversion of the value provided to the original module.

16. The method of claim 1, wherein performing the information flow tracking process comprises performing the information flow tracking process during a simulation process, a formal verification process, or a hardware emulation process.

17. A system comprising: one or more computers and one or more storage devices storing instructions that are operable, when executed by the one or more computers, to cause the one or more computers to perform operations comprising:
receiving an initial hardware design having an original module with a plurality of original inputs for tracking a value through the initial hardware design;
generating a modified hardware design including:
adding a duplicate module for the original module, the duplicate module having a plurality of duplicate inputs corresponding respectively to the plurality of inputs of the original module, and adding combination logic that combines one or more outputs of the original module with one or more outputs of the duplicate module to generate a final output;
performing an information flow tracking process including feeding a value through the modified hardware design, including providing a different value to a duplicate input whenever the value is provided to the module having a particular security label; and
determining whether the value can flow through the module based on the final output of the combination logic.

18. The system of claim 17, wherein the duplicate module performs the same internal function as the original module.

19. The system of claim 17, wherein the original module is a module that is not synthesizable in the hardware design.

20. One or more non-transitory computer storage media encoded with computer program instructions that when executed by one or more computers cause the one or more computers to perform operations comprising:
receiving an initial hardware design having an original module with a plurality of original inputs for tracking a value through the initial hardware design;
generating a modified hardware design including:
adding a duplicate module for the original module, the duplicate module having a plurality of duplicate inputs corresponding respectively to the plurality of inputs of the original module, and
adding combination logic that combines one or more outputs of the original module with one or more outputs of the duplicate module to generate a final output;
performing an information flow tracking process including feeding a value through the modified hardware design, including providing a different value to a duplicate input whenever the value is provided to the module having a particular security label; and
determining whether the value can flow through the module based on the final output of the combination logic.
